(19) United States
(12) Patent Application Publication
(10) Pub. No.: US 2008/0085018 A1
(43) Pub. Date: Apr. 10, 2008

(54) Apparatus and method for sonic cleaning of an air filter for wheeled and tracked vehicles

(76) Inventors: Ronald C. Troxell, (US); Praveen Panickef, (US); Ralph Muehlisen, Chicago, IL (US); Roy E. Greenlees, Lake Forest, IL (US); Jason D. Troxell, Chicago, IL (US)

Correspondence Address: Orum & Roth LLC, 53 W. Jackson Blvd., Chicago, IL, 60604, US

(21) Appl. No.: 11/545,856

(22) Filed: Oct. 10, 2006

(51) Int. Cl. H04R 23/00

(52) U.S. Cl. 381/150; 381/86

(57) ABSTRACT

An air filter apparatus and method for a land vehicle is disclosed wherein sound waves are directed onto the filter element of the filter device to dislodge particulate matter without the need to disassemble the air filter device.

### BACKGROUND OF THE INVENTION

1. Field of the Invention

The present invention relates to a method of cleaning air filters using a sonic horn. In particular, it related to a method of cleaning air filters for wheeled and tracked vehicles.

2. Summary of the Prior Art

Wheeled and tracked vehicles are typically used in harsh conditions such as deserts, construction sites and other areas where the air filters can become clogged quickly. Thus, the engine air intake air cleaners of wheeled and tracked vehicles require frequent maintenance in dusty environments.

Typically when an engine air intake filter becomes loaded with contaminant the operator or vehicle maintenance person must remove the filter from the air cleaner housing. The filter is then either manually cleaned with compressed air or physically tapped against a solid surface to remove the accumulated dirt. If the filter cannot be cleaned adequately through these methods it must be replaced. Both options are time consuming, requiring the vehicle to be out of service during that period, and costly. The cleaning is often performed at least once a day. Even with the cleaning, the air filters often need to be replaced as frequently as once per week.

The project must be stopped and the air filter removed to perform the cleaning. The filter may not be cleaned adequately due to time limitations, differences in the individuals who are performing the cleaning, etc. There is a need for a method of cleaning air filters that reduces the time required for cleaning, allows the cleaning to be done while the air filter is still on the vehicle and extends the useful life of the vehicle by providing a consistent level of cleaning.

Sonic horns have been in use in the industrial dust collection industry for in-place cleaning of large dust collectors. These horns are large, as much as eight feet long, are very loud and use considerable amounts of energy to operate. Lower level frequency sound waves impart more mechanical energy than higher frequency sound. Thus, low frequencies are required to provide adequate cleaning. As sonic horns are made smaller the sound frequency levels that they can generate becomes higher. Smaller horns provide less of these low frequency sound levels and have been considered unsuitable for use in applications requiring substantial mechanical action, such as cleaning. These conditions have made sonic horn unsuitable for use on anything other than large industrial products.

There is a need for a method of using a sonic horn for cleaning the air filter of vehicles which provides sufficient energy to and an appropriate cleaning frequency in a small size, that can be powered far from convention sources of electricity, and which are not painful for people to be near.

### SUMMARY OF THE INVENTION

The invention provides a means to clean the intake air filter without removing it from the vehicle, thus reducing the amount of maintenance required and extending the service life of the filter and consequently reducing the operating cost of the vehicle.

The filter cleaning action is accomplished with the use of a sonic horn; a device that generates low frequency, high-energy sound that lifts the dust from the surface of the filter and through a vibrating motion transports it away from the filter. This invention provides a means to apply very small, low energy usage horns to mobile equipment.

Through sonic horn design and critical placement of the horn, or multiple horns on or in the air cleaner housing allows the use of small sized horns that can provide adequate energy to clean the filter surface with low operating energy requirements and without generating objectionable noise levels. This cleaning action can be assisted with the release of compressed air to the inside of the filter surface, which will blow the sonically released dust away from the filter. The use of the compressed air is not necessary to achieve adequate cleaning action but can be used to augment the effectiveness of the sonic horn.

The design of the sonic horns will allow for operating power to be supplied either as low voltage direct current from the vehicle's electrical system or a horn that operates on compressed air can be chosen. Many commercial, industrial and military vehicles have a source of compressed air on the vehicle.

### BRIEF DESCRIPTION OF THE FIGURES

FIG. 1 is a flow chart of the inventive method.

FIG. 2 is a perspective view of the canister

FIG. 3 is a perspective view of the canister

FIG. 4 is a perspective view of the device showing the pressure profile at one frequency

FIG. 5 is a perspective view of the device showing the pressure profile at one frequency.

FIG. 6 is a perspective view of the device showing the pressure profile at one frequency.

FIG. 7 is a perspective view of the device showing the pressure profile at one frequency.

FIG. 8 is a perspective view of the device showing the pressure profile at one frequency.

FIG. 9 is a perspective view of the device showing the pressure profile at one frequency.

FIG. 10 is a perspective view of the device showing the pressure profile at one frequency.

FIG. 11 is a perspective view of the device showing the pressure profile at one frequency.

FIG. 12 is a perspective view of the device showing the pressure profile at one frequency.

FIG. 13 is a perspective view of the device showing the pressure profile at one frequency.

FIG. 14 is a perspective view of the device.

FIG. 15 is a perspective view of the device showing the pressure profile at one frequency.

FIG. 16 is an elevation view plot of the acoustic pressure gradient.

FIG. 17 is a plan view of the acoustic pressure gradient.

FIG. 18 is a graph of sound pressure vs. frequency.

FIG. 19 is a graph of sound pressure vs. frequency.

FIG. 20 is a graph of sound pressure vs. frequency.

FIG. 21 is a profile view of the device.

FIG. 22 is a profile view of the device.

FIG. 23 is a perspective view of the device showing a pressure profile.

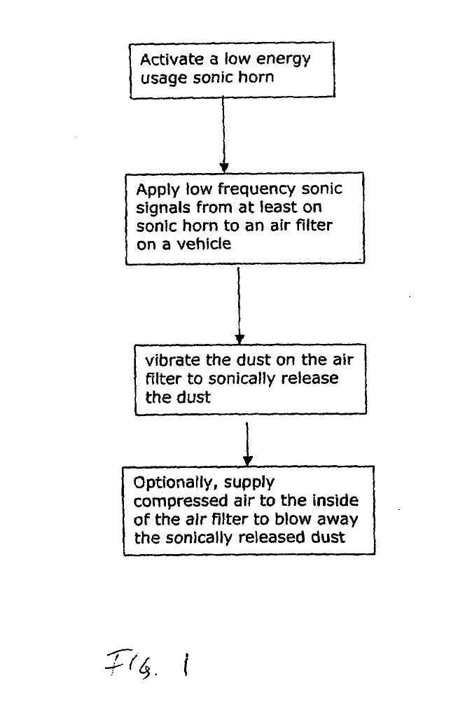

### DETAILED DESCRIPTION OF THE INVENTION

The invention provides a means to clean the intake air filter without removing it from the vehicle, thus reducing the amount of maintenance required and extending the service life of the filter and consequently reducing the operating cost of the vehicle.

The filter cleaning action is accomplished with the use of a sonic horn; a device that generates low frequency, high-energy sound that lifts the dust from the surface of the filter and through a vibrating motion transports it away from the filter. This invention provides a means to apply very small, low energy usage horns to mobile equipment.

Through sonic horn design and critical placement of the horn, or multiple horns on or in the air cleaner housing allows the use of small sized horns that can provide adequate energy to clean the filter surface with low operating energy requirements and without generating objectionable noise levels. This cleaning action can be assisted with the release of compressed air to the inside of the filter surface, which will blow the sonically released dust away from the filter. The use of the compressed air is not necessary to achieve adequate cleaning action but can be used to augment the effectiveness of the sonic horn.

The design of the sonic horns will allow for operating power to be supplied either as low voltage direct current from the vehicle's electrical system or a horn that operates on compressed air can be chosen. Many commercial, industrial and military vehicles have a source of compressed air on the vehicle.

At low frequency sonic horn is part of the air filter. The placement of the sonic horn is important. The sonic horn use low frequencies to vibrate the dust from the surface of the air filter. Gravity is used to remove the sonically released dust from the filter. Compressed air can be used to augment the effectiveness of the method of cleaning the air filter, by blowing away the sonically released dust.

In the preferred embodiment, the wheeled or tracked vehicle is stopped during the cleaning process. Alternatively, the sonic horn could be activated while the vehicle is moving.

In the preferred embodiment, the sonic horn is activated manually. In an alternative embodiment, the sonic horn is activated automatically, such as after a specified amount of time has passed.

In the preferred embodiment, a low energy usage sonic horn is used.

In order to use acoustic methods to loosen particulate from a filter, the acoustic system must be capable of producing extreme sound levels, inducing large acoustic velocities, on the surface of the filter. Given the size and cost constraints of a military vehicle filter, the very large, low frequency transducers used in industrial and agricultural filter systems cannot be used. To produce very high sound levels from a small transducer, higher frequencies must be used and natural acoustic enhancement of the sound field through acoustic resonance of the canister/filter needs to be utilized. To begin the design process a good knowledge of the resonance characteristics (i.e. the acoustic modes) of the canister/filter is required. In particular, knowledge of the resonance frequencies, pressure mode shapes, and the acoustic velocities are required.

When the resonance frequencies and mode shapes are known, the frequency of the transducers, required transducer strength, and the transducer locations can be determined and a more complete simulation and construction of a prototype can begin.

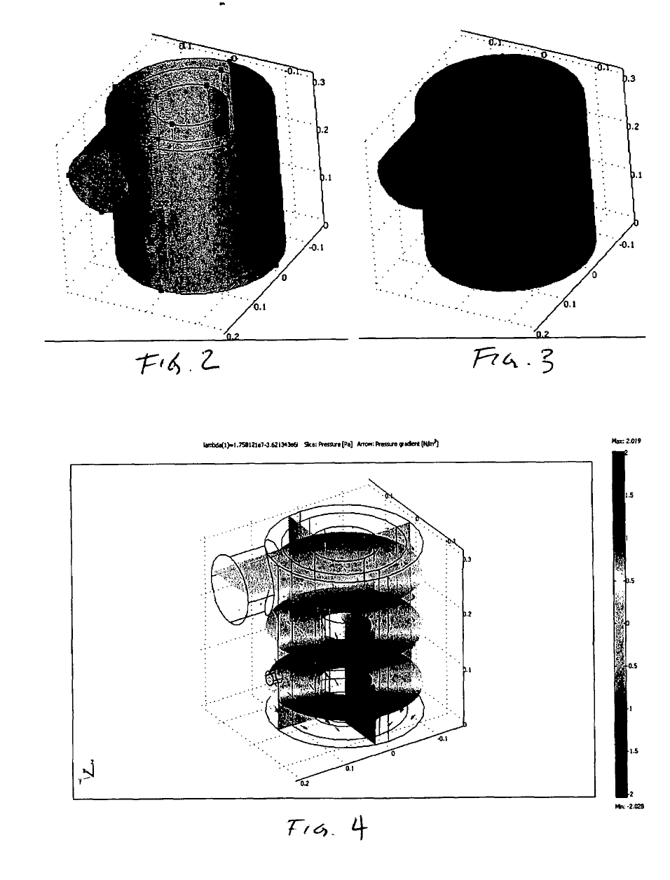

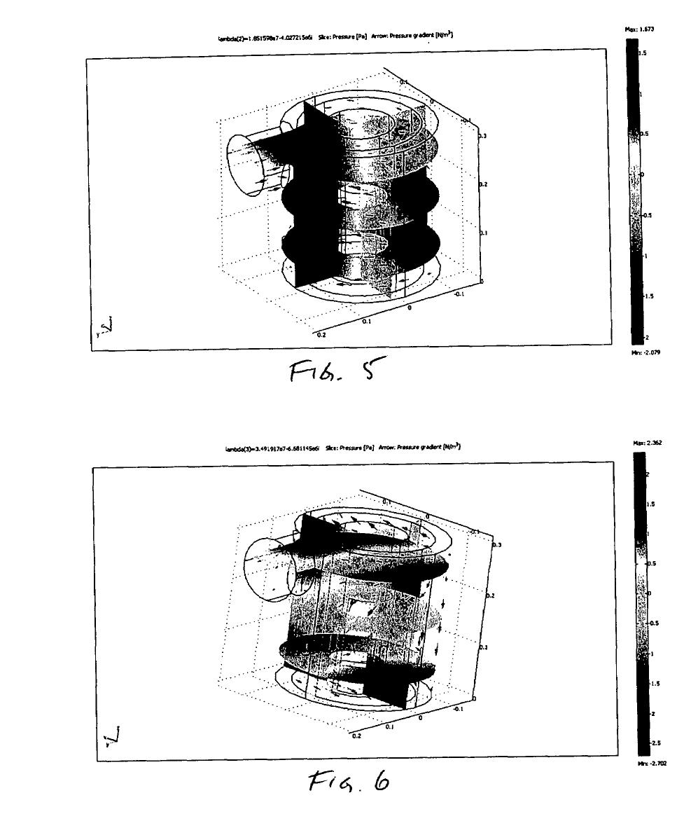

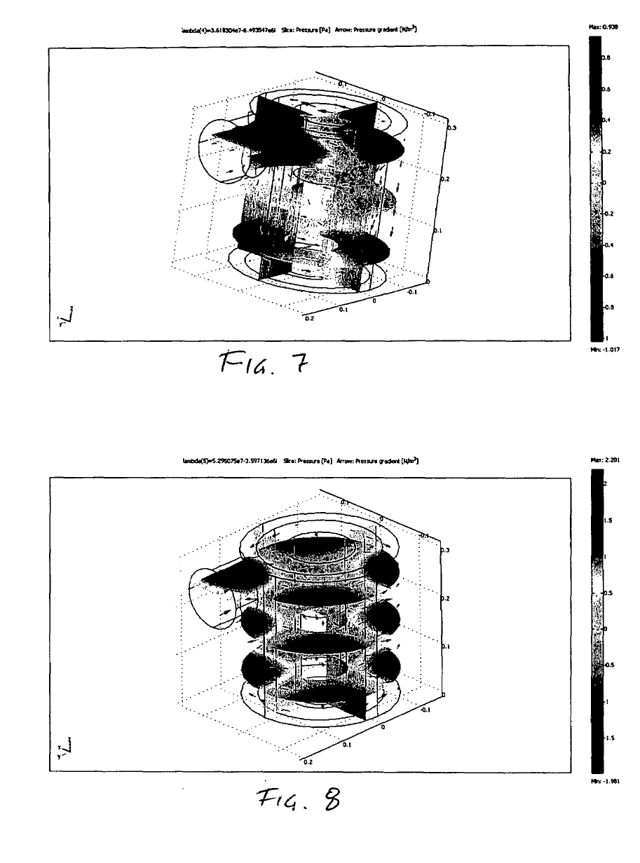

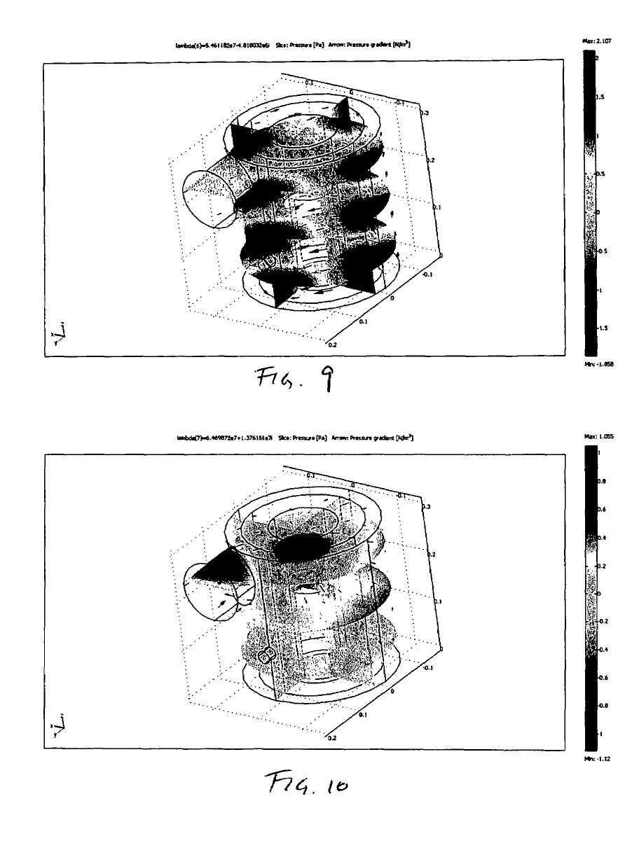

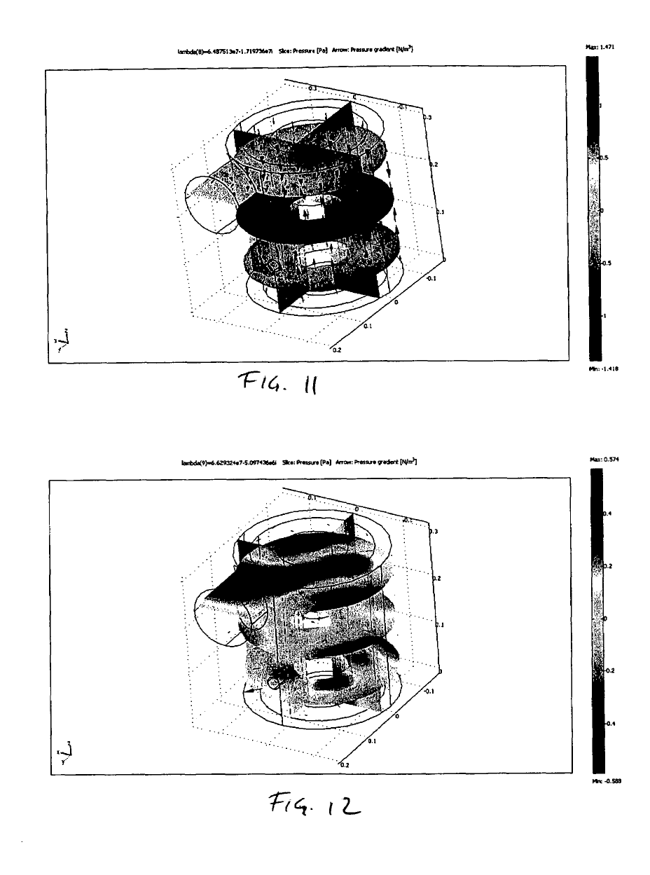

A simplified 3-D acoustic finite element model (FEM) of the HMMWV air cleaner has been developed. The model consists of a rigid canister with the air inlet extension as shown in FIGS. 2,3 below. Inside the canister, the space has been separated into three radial regions. The outer and inner are air and the center region is the air filter, modeled as a highly damped dispersive media. The outlet tube is modeled but that is not seen in the figures below. Also shown in the figure is the FEM mesh. This system was analyzed to determine the resonance frequencies and shapes of the acoustic modes. These acoustic modes are the natural resonance conditions for the canister/filter system. They are the frequencies where resonant enhancement of the transducer output will occur.

The computations were analyzed to determine the resonance frequency, the acoustic pressure variations and the acoustic velocity vectors of each mode. Of particular interest are modes that have acoustic pressure variations and acoustic velocities that would induce motion of the particulate on the filter surface in a manner that would dislodge them. Longitudinal modes with variations along the length of the canister and azimuthal modes with variations around the circumference of the canister will have acoustic velocities parallel to the surface of the filter. These may be the best modes for loosening particulate. Sloshing modes with side to side variations are another mode. Radial modes will have radial pressure variations and acoustic velocities. These will alternately pull the particulate off the filter surface and then push the particulate back on.

The plots that follow are an analysis of the first ten acoustic modes of the canister. They range in frequency from 670 Hz to 1344 Hz. The modes with frequencies above 1000 Hz are more interesting because the small, efficient, robust, and inexpensive transducers required to excite these modes are more readily available at the higher frequencies. The analysis shows a cluster of three modes around 1290 Hz, two of which are radial and one of which is longitudinal. A tone at 1292 Hz would probably excite all three modes well with a very complex resulting motion.

Transducer excitation can be varied to determine how much to excite each mode and if the resulting multimodal excitation would be an enhancement to particulate motion or a detriment.

The two modes at 670 Hz FIG. 4 and 681 Hz FIG. 5 are side to side modes where the pressure variation and particle motion is simply side to side in the canister.

The two modes at 945 Hz FIG. 6 and 961 Hz FIG. 7 show large pressure variation along the canister length. These modes are productive in moving particulate up and down on the side of the filter.

The two modes at 1159 Hz FIG. 8 and 1178 Hz FIG. 9 show strong azimuthial pressure variations. They are able to move particulate around the circumference of the filter.

The mode at 1288 Hz FIG. 10 is a radial mode with pressure variation along the radius. Particulate motion would be towards and away from the center. This may be good at pulling particulate off.

The mode at 1292 Hz FIG. 11 is a very strong longitudinal mode that will produce pressure variation and particulate motion along the length of the canister.

The mode at 1296 Hz FIG. 12 is another radial mode with pressure variation and particulate motion primarily towards and away from the center.

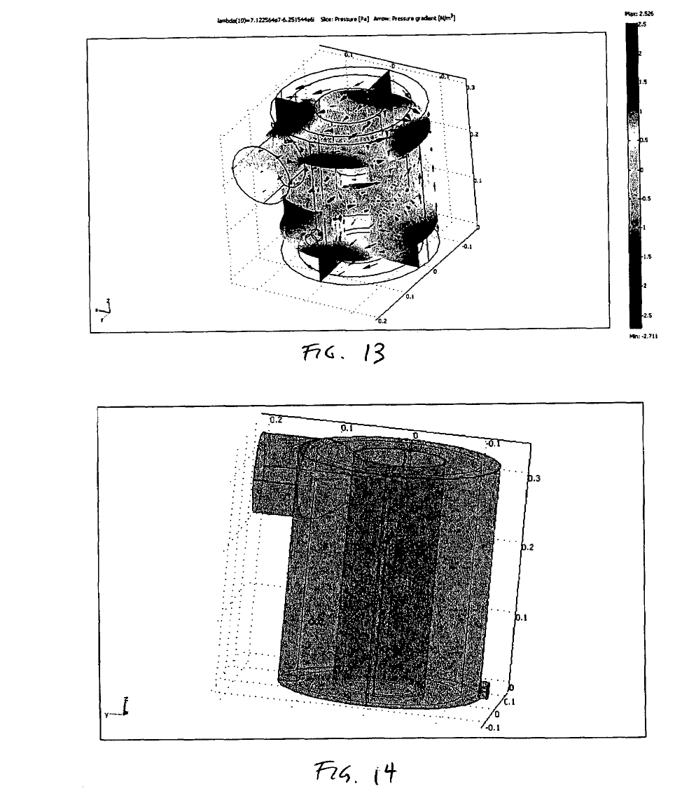

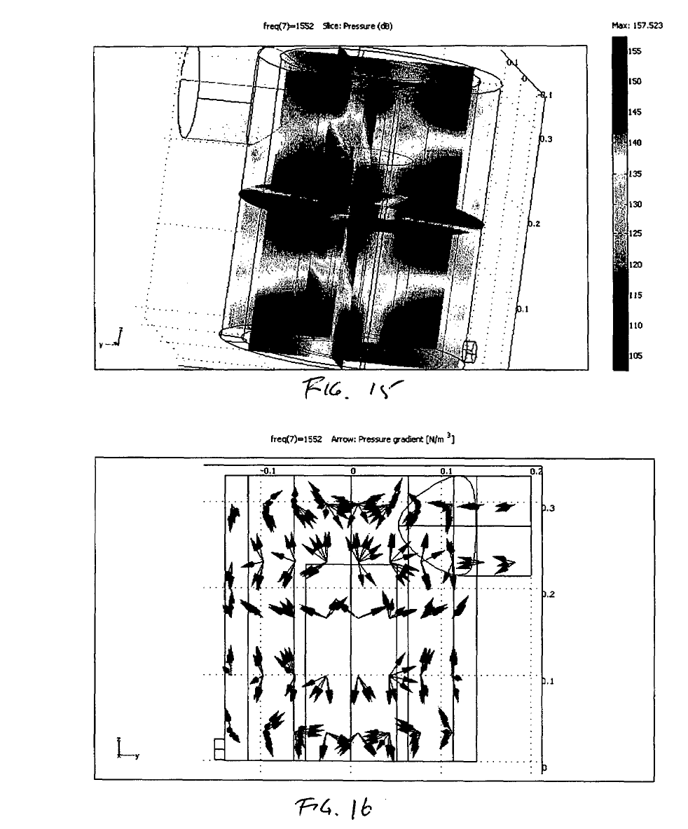

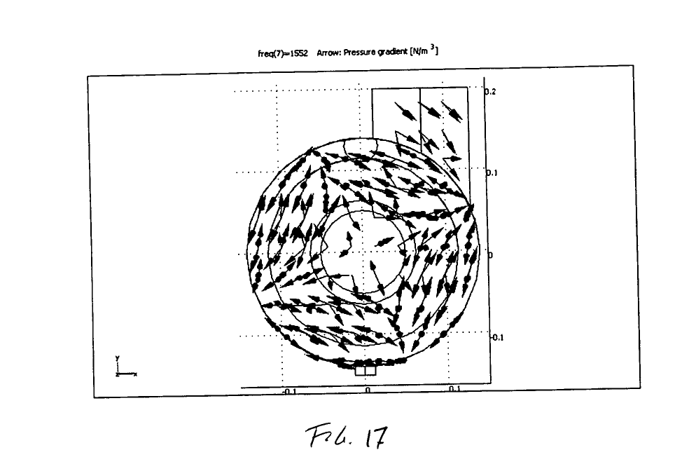

The mode at 1344 Hz FIG. 13 is a combination radial and longitudinal mode. There is pressure variation and particle motion up and down and center to edge.

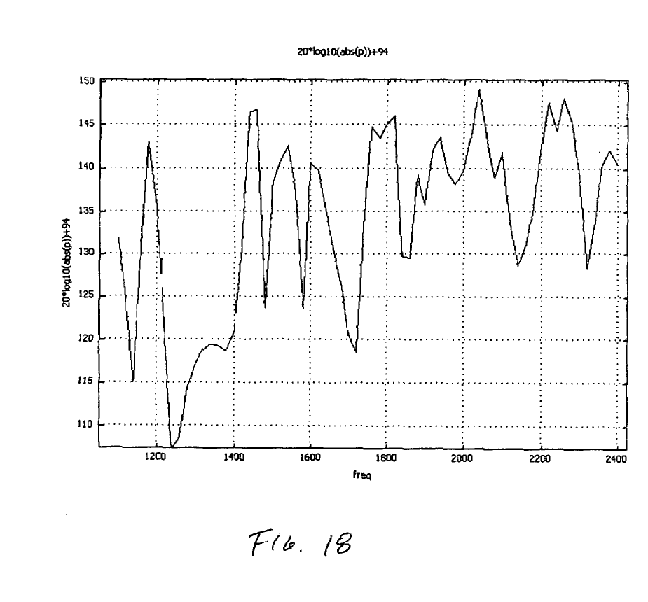

Using COMSOL (formerly called FEMLAB) software a simple circular duct was modeled. See FIG. 14.

Next, a model of the HMMWV filter canister with a filter was developed independently. The independently developed model and the earlier model predict the same resonance frequencies.

There was a cluster of modes with resonance frequencies in the 1500 to 1600 Hz range. This is a frequency range that can be strongly driven with off-the-shelf sound reinforcement horn drivers for testing purposes. Additionally, the frequency is high enough that a high efficiency, compact piezoelectric driver could be designed to drive the resonance in a production product.

A model was developed which included a transducer. The transducer was modeled as a surface with a fixed acceleration. This is a very good approximation to an electrodynamic or piezoelectric loudspeaker. The transducer selected for the model produces about one watt of acoustic power. This is a large acoustic power output, but certainly an output achievable with off-the-shelf sound reinforcement drivers.

Sound pressure levels for excitation of several of the modes were found during natural frequency analysis. Mode shapes were mapped out for a particular choice of driver location.

The initial simulations were done with a random placement of the transducer. The first position was on the side of the canister about ⅗ of the length from one end. This t is very near to a node for strong axial (end-to-end) resonances. The maximum sound pressure level obtained was less than 130 dB.

The transducer was placed at one end of the canister so as to maximally excite the axial (along the length of the canister) modes.

Tests were conducted with the transducer positioned between the filter and the outside canister

Tests were conducted with the transducer positioned between the filter and the outside canister wall, with the transducer completely under the filter, and with the transducer half way under the filter and half way between the filter in the canister wall. It may be expected that the position between the canister wall and the filter would produce the highest output. The position between the filter and the canister was indeed the best.

With one acoustic watt from the driver, sound levels in excess of 150 dB were excited. At a frequency of about 1550 Hz, a very strong axial mode in conjunction with a strong circumferential mode was excited. There are strong pressure gradients along the length and around the side of the filter—this is the type of excitation that will best dislodge a particulate from the filter. A radial mode will have gradient away from the filter wall, but that is followed by a gradient toward the filter wall so it is not clear that a radial mode would help re-move particulate—it may just impact it further onto the filter.

It was noticed that an end position of the speaker could be a problem for testing as the outlet port might interfere with installation of a large horn driver. The position of the driver was subsequently moved back to the side of the canister, but very near the bottom. There was little change in the response. The new location of the transducer can be clearly seen in the lower right corner of FIG. 14.

Simulations of the speaker being excited at 1552 Hz show the expected excitation of an axial mode as well as a circumferential mode. FIG. 15 shows two nodal lines in the axial direction and four nodal lines circumferentially.

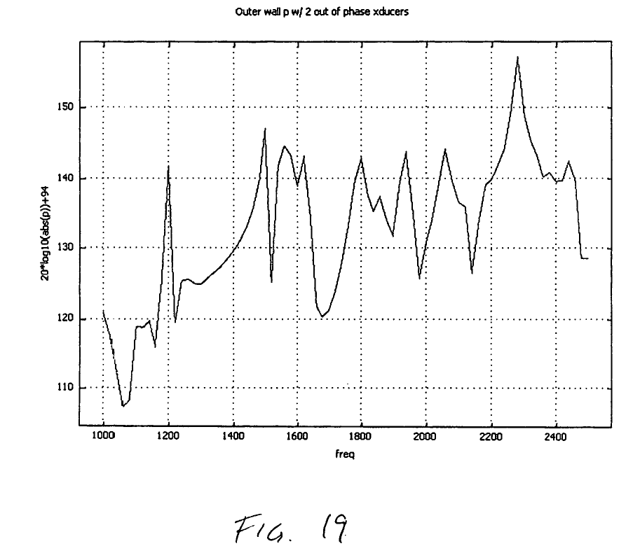

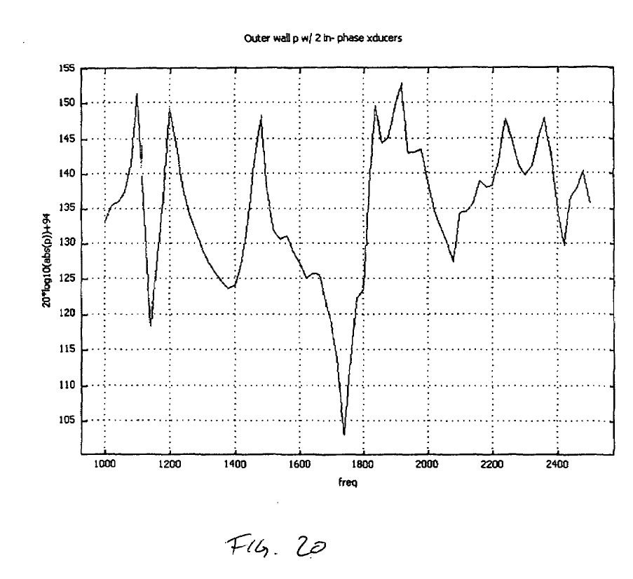

Plots of the acoustic pressure gradient are shown in FIGS. 16 and 17. The pressure gradient is expected to drive the motion of the particulate. From the elevation view plot of FIG. 16 it can be seen that there is significant gradients in the axial direction. From the plan view plot of FIG. 17 it can be seen that there is also significant circumferential pressure gradients but not much radial gradients, especially at the outer surface of the filter. With this set of results, a placement of a transducer mount on the side and at the bottom of the filter canister is suggested. The figures show a placement of the transducer mount on the side opposite the air inlet port. The position of the mount in the circumferential direction is of lesser importance.

The response output may be further improved by further testing other transducer positions. Additional transducers may be added in appropriate locations and with appropriate phasing to excite only preferred modes.

A canister is disclosed with a slide mount for the loudspeaker. Using a loudspeaker, an audio amplifier, and a laptop with a simple tone generator software as a source, it is possible to loudly excite the canister with pure tones. It is possible to excite a very strong mode near 1220 HZ BUT NOT NEAR 1550 Hz. Dust is released when playing a loud tone in the 122-Hz range.

Another cluster of modes existed just above 1200 Hz. It may be noted that several of these were radial modes.

The modes near 1200 Hz were excited quite a bit more than those around 1550 Hz. Another set of strong modes were found near 1700 Hz. It was noted that the speaker source was actually located nearly 1.5 inches from the end of the canister rather than at the very bottom as was modeled in COMSOL. Dust is released at 1220 Hz but not at 1550 Hz. A frequency chirp from 1200-2000 Hz did an even better job of releasing dirt than a single 1220 Hz tone.

The model was updated with the speaker position moved to match the experimental setup. It was found that the new location, the 1200 Hz cluster of modes was indeed excited more than the 1550 Hz cluster. Excitation of longitudinal modes was highly sensitive to the position of the transducer-far more than radial or axial modes. A canister may be provided with the speaker mounted as close to one end as possible.

Actual particle motion may be modeled using COMSOL. Particle motion appears to be modeled only with true transient simulation rather than steady state simulation. It was deemed impractical to try to model a steady state mid frequency acoustic system using a transient simulation.

A new canister was developed that removed the inner tube as well as a new filter with a more shallow pleat and a material that should release particulate easier. The new canister also has the transducer mounted very close to the end of the can.

The COMSOL model was updated to match the current canister configuration and is shown in FIG. 21. A frequency sweep of the canister can be used to generate a frequency response curve which can be compared to models. FIG. 18 is the predicted pressure response for a frequency sweep from 1000 Hz to 2500 Hz for a single transducer.

The major resonance frequencies match between the real canister measurements and the model predictions.

One embodiment more accurately predicts the actual resonance frequencies better than the previous model. A new speaker with higher output capability was used in the experiments. A number of frequency sweep ranges were tested and it was found that sweeps from 1200-2000 Hz and 1400-2400 Hz both were able to loosen significant amounts of dust.

The radial modes are actually very useful. It is now thought that the frequency sweep works so well because it actually excites the particles in a way such that a radial mode will pull the particulate off of the filter and then the longitudinal and axial modes will pull the airborne dust away from the filter.

High output piezo buzzers and sirens are disclosed. Piezo alarms with two tones or with a chirp are fairly inexpensive and robust. They appear to be ideal candidates for a prototype transducer.

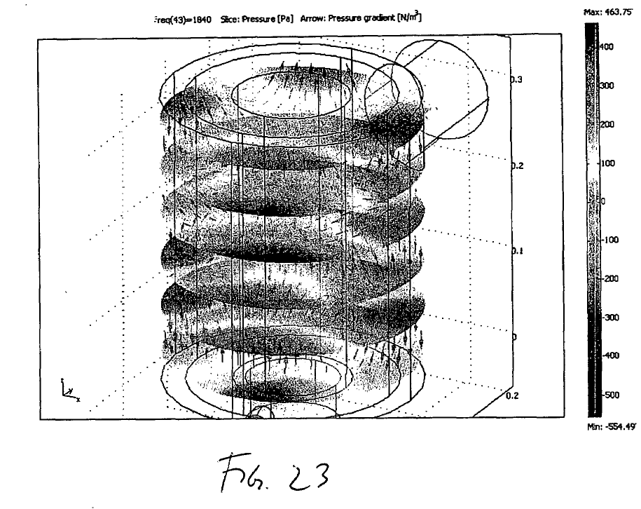

The COMSOL model for a system with two transducers show some interesting results. FIG. 22 shows the basic COMSOL model for the two transducer driver.

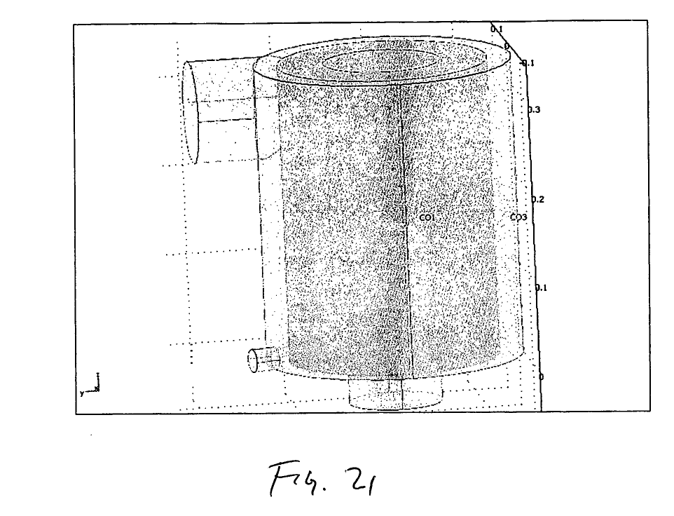

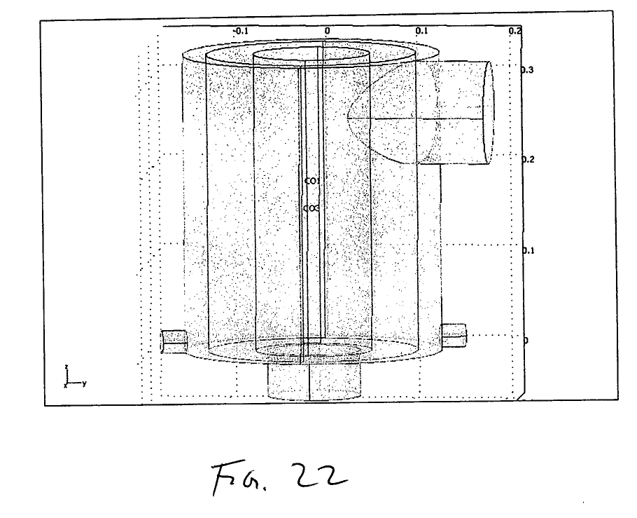

FIG. 19 shows plot of the frequency response for two transducers that are mounted opposite one another and are out of phase while FIG. 20 shows a plot when the transducers are in phase. Looking at the plots, two out of phase transducers have a strong, isolated resonance about 1200 Hz and a very strong resonance near 2300 Hz. The two in phase transducers have some strong isolated resonances at 1100 Hz, 1200 Hz, and 1500 Hz and a very strong cluster around 1800 Hz. These modes or mode clusters may generate useful particulate motion.

An example of the excited mode shapes is shown in FIG. 23. The mode shown consists mostly of circumferential modes and longitudinal modes.

Multitone and chirp excitation signals are disclosed, as well as an actual measurement of the amount of dust removed from the filter. Sweeps in the 1800 Hz to 2400 Hz range are disclosed.

A second transducer may be mounted to the canister. A production piezo buzzer or siren is disclosed for installation in/on a canister.

1. An apparatus for filtering air, comprising:
a housing,
a filter element disposed at least partially within the housing,
an air input,
an air output,
and at least one sound generating device arranged and constructed to generate sound pressure waves in the range of 600-3000 Hz,
wherein said sound pressure waves interact with the filter element to dislodge particulate matter attached to the filter element.

2. An apparatus according to claim 1, wherein said sound generating device is an acoustic transducer.

3. An apparatus according to claim 1, wherein said sound generating device generated sound pressure waves in the range of 650 Hz-700 Hz.

4. An apparatus according to claim 1, wherein said sound generating device generated sound pressure waves in the range of 900 Hz-980 Hz.

5. An apparatus according to claim 1, wherein said sound generating device generated sound pressure waves in the range of 1000 Hz-1200 Hz.

6. An apparatus according to claim 1, wherein said sound generating device generated sound pressure waves in the range of 1200 Hz-1400 Hz.

7. An apparatus according to claim 1, wherein said sound generating device generated sound pressure waves in the range of 1200 Hz-2000 Hz.

8. An apparatus according to claim 1, wherein said sound generating device generated sound pressure waves in the range of 1400 Hz-2400 Hz.

9. An apparatus according to claim 1, wherein said sound generating device generated sound pressure waves in the range of 1800 Hz-2400 Hz.

10. An apparatus according to claim 1, wherein said housing is affixable to a land vehicle.

11. An apparatus according to claim 1, wherein said sound generating device comprises at least two sound generating elements.

12. A method for removing particulate matter from an air filter in a housing attached to a land vehicle, comprising the steps of:
activating a low energy sound generating device,
directing sound waves in the frequency range of 650 Hz-3000 Hz to a filter element of the air filter,
releasing particulate matter from the filter element via the sound waves,
and removing the particulate matter from the air filter.
